(19) United States
(12) Patent Application Publication
(10) Pub. No.: US 2016/0189743 A1
(43) Pub. Date: Jun. 30, 2016

(54) DISC SPIN SPEED PROFILE FOR AN OPTICAL DISC

(71) Applicant: KONINKLIJKE PHILIPS N.V., Eindhoven (NL)

(72) Inventors: Wooi Liang CHIN, Singapore (SG); Wiebe DE HAAN, Eindhoven (NL)

(21) Appl. No.: 14/909,748

(22) PCT Filed: Feb. 26, 2014
(86) PCT No.: PCT/IB2014/059272

§ 371 Date: Feb. 3, 2016

(30) Foreign Application Priority Data
Aug. 28, 2013 (EP) 13181988.0

(51) Int. Cl. G11B 19/28; G11B 19/26; G11B 19/12

(52) U.S. Cl. CPC G11B 19/28; G11B 19/12; G11B 19/26

(57) ABSTRACT

Creating a disc spin speed profile allows the player to store this disc spin speed profile and control disc spin speed based on this disc spin speed profile, simplifying the disc spin speed adjustment. Instead of using a Constant Linear Velocity profile matched to the highest data rate prescribed by the standard, the playback device can establish its own disc spin speed profile that is adapted to the data rate requirements as they vary across the record carrier. Starting the disc spin speed profile with a Constant Angular Velocity part, followed by a Constant Linear Velocity part reduces the disc spin speed at zones at the innermost of the disc, reducing noise and energy consumption.

### TECHNICAL FIELD OF THE INVENTION

The invention relates to a disc shaped record carrier comprising a track for holding data, a player for such disc and a server holding a table for such disc.

### BACKGROUND ART

Such record carriers are well known in the field of optical recording where data is stored in a digital format in a track on the record carrier.

In today's players, the disc spin speed is highest at the inner most radius and the data rate achieved at any address on the disc is expected to meet the maximum bit rate defined in the standard regardless of what a particular disc or title actually requires. If the standard defines the maximum data rate that can be expected from any movie disc, the player needs to achieve this worst case data rate even though a particular title that do not require such high data rate.

This results in noise because of the unnecessary high spin speed the disc will spin at a speed higher than required.

In US2005105885 a method is provided for variably controlling a read disc spin speed in an optical disc drive. The method includes determining whether or not a read command has been issued; if the determining step determines that the read command has been issued, examining additional information associated with the read command; and variably controlling a read disc spin speed for an optical disc according to the additional information. Thus the host issuing the read command controls the disc spin speed.

This has the disadvantage when data rates vary along the track that the host has to determine what disc spin speed it needs and adjust the disc spin speed according to its needs.

It is the objective of the present invention to overcome this disadvantage.

### DISCLOSURE OF THE INVENTION

In order to overcome this disadvantage the record carrier according to the present invention is characterized in that the record carrier is associated to a table holding data rate indicators indicating for each zone of the track an optimal read/write data rate where the optimal read/write data rate is based on a maximum data rate required by the data held in said zone of the track.

By providing a table containing a data rate indicator for each zone of the track the player can retrieve the table and without analysis of the data set the optimal disc spin speed at which the data in a zone is to be read. The information of the disc data rate requirement (effectively a data rate profile of the disc) is provided by the content owner.

In an embodiment the data rate indicator indicates a maximum data rate of the data held in said zone of the track.

As the player knows the relationship between disc spin speed and data rate for each zone of the track, providing the maximum data rate indicator in the table enables the player to determine the minimum disc spin speed needed to accommodate this maximum data rate, resulting in the lowest noise levels possible.

In another embodiment the table is located on a server.

By locating the table on a server the table can be centrally adjusted to reflect new information on the playability of the record carrier. For instance when complaints from the field reach the content owner that the data rate in the table is too high or too low for proper playback, the content owner can use this information or other new insights and adjust entries in the data rate indicator table to remedy the complaints. From that moment on, whenever a record carrier with this content is to be played the player will access the updated table on the server and retrieve the corrected data rate indicators and use these for setting the data rate and thus disc spin speed.

In another embodiment the table is located on the record carrier.

Instead of locating the table on a server the table can also be located on the record carrier itself.

This ensures that the player does not need to access the server when retrieving the content from the record carrier. The player merely needs to retrieve the table from the record carrier before retrieving the content of the record carrier and can from that moment on adjust the data rate to the optimal value as retrieved from the table.

In an embodiment of the record carrier, the table is located in a lead-in area of the record carrier.

The lead-in is read before the content is retrieved from the data area and the table is thus automatically read before the retrieval of the content commences.

In an embodiment of the record carrier the table is recorded in a groove modulation.

By recording the table in a groove modulation the retrieval can be performed in parallel to the retrieval of the content from the data area. The data area can thus be fully used for storing the content.

In an embodiment of the record carrier the table is recorded in a data area of the record carrier.

Storing the table in the data area ensures that no compatibility issues arise by introducing the table to an area with reserved functionality where a player does not expect to find such a table.

In an embodiment of the record carrier the table is recorded in a file.

By storing the table in a regular file it can be named and easily retrieved by players that support the use of the table while players (for instance legacy players) that do not support the use of the table can safely ignore the file.

In an embodiment the record carrier comprises a menu, a set of bonus material files or record carrier startup files required upon startup of the record carrier, located in a zone requiring the highest number of record carrier rotations per minute to achieve a selected data rate of all zones on the record carrier.

The record carrier startup files, bonus material files and menus typically require a lower data rate than the movie data. Positioning them on the record carrier where the record carrier has to be spun fastest (highest rotations per minute) to achieve a certain data rate allows a further reduction of the disc spin speed. On a disc shaped record carrier the inner most zone(s) of the disc that is(are) available for recording is(are) the optimum position to store these files.

In an embodiment the record carrier comprises an additional table holding a read sequence indicator indicating an optimal read sequence for the set of record carrier startup files.

Including a read sequence indicator allows the player to retrieve this indicator and retrieve the record carrier startup files in an optimal sequence ensuring that the optical pickup unit of the player does not need to return to the table of contents file of the record carrier after each record carrier startup file that has been retrieved. During authoring of the record carrier the record carrier startup files are arranged in a optimal sequence on the record carrier and the corresponding read sequence indicator is placed in the additional table.

In an embodiment sections of the data requiring a lowest data rate of all data sections are located in a zone requiring the highest number of record carrier rotations per minute to achieve a selected data rate of all zones on the record carrier

Sections of the movie data requiring the lowest data rate of all sections of the movie can be positioned in the inner zones of the record carrier, reducing the data rate in the inner zones, and consequently reducing the disc spin speed for these zones. Although this embodiment also benefits from the presence of the table holding data rate indicators indicating for each zone of the track an optimal read/write data rate, it can also be used independently and merely rely on the current mechanism on the record carrier to indicate the order of playback of the movie data or order in which sectors are to be retrieved for instance a playlist, sector numbering or the file system. This effectively changes the order of the sections of the data by removing low data rate sections from their original position and repositioning them at the inner zones of the disc, thus reducing the disc spin speed when retrieving the repositioned sections. Even though this inherently introduces some seek actions by the player during playback these jumps can be easily handled using the buffer that is already present in all current players to be able to seamlessly play video during a layer jump.

A server comprising a table relating to a disc shaped record carrier comprising a track for holding data, according to the invention comprises the table that holds data rate indicators indicating for each zone of the track an optimal read/write data rate where the optimal read/write data rate is based on the data held in said zone of the track.

A player according to the invention is characterized in that the player comprises a table retriever and a disc spin speed adjuster, where, when retrieving a zone of the track, the disc spin speed adjuster is arranged to adjust the disc spin speed of the record carrier to achieve a data rate equal to the maximum data rate as derived by the table retriever from the table for that zone of the track.

In an embodiment of the player the data rate indicator indicates a maximum data rate of the data held in said zone of the track.

As the player knows the relationship between disc spin speed and data rate for each zone of the track, providing the maximum data rate indicator in the table enables the player to determine the minimum disc spin speed needed to accommodate this maximum data rate, resulting in the lowest noise levels possible.

In a further embodiment of the player the disc spin speed adjuster is arranged to create a disc spin speed profile which is a combination of a constant angular velocity profile with a constant linear velocity profile.

Creating a disc spin speed profile allows the player to store this disc spin speed profile and control disc spin speed based on this disc spin speed profile, simplifying the disc spin speed adjuster. Instead of using a Constant Linear Velocity profile matched to the highest data rate prescribed by the standard, the playback device can establish its own disc spin speed profile that is adapted to the data rate requirements as they vary across the record carrier. Starting the disc spin speed profile with a Constant Angular Velocity part, followed by a Constant Linear Velocity part reduces the disc spin speed at zones at the innermost of the disc.

In a further embodiment of the player the player comprises networking means for retrieving the table from a server.

By locating the table on a server the table can be centrally adjusted to reflect new information on the playability of the record carrier. For instance when complaints from the field reach the content owner that the data rate in the table is too high or too low for proper playback, the content owner can use this information or other new insights and adjust entries in the data rate indicator table to remedy the complaints. From that moment on, whenever a record carrier with this content is to be played the player will access the updated table on the server via its networking means and retrieve the corrected data rate indicators and use these for setting the data rate and thus disc spin speed.

In a further embodiment of the player the table is retrieved from the record carrier.

Instead of locating the table on a server the table can also be located on the record carrier itself.

This ensures that the player does not need to access the server when retrieving the content from the record carrier. The player merely needs to retrieve the table from the record carrier using the table retriever before retrieving the content of the record carrier and can from that moment on adjust the data rate to the optimal value as retrieved from the table.

### BRIEF DESCRIPTION OF THE DRAWINGS

FIG. 1 shows a player according to the invention.

FIG. 2 shows a maximum data rate profile for a disc.

FIG. 3 shows a disc spin speed profile as used by the prior art.

FIG. 4 shows a table with the maximum data rate per zone of the disc.

FIG. 5 shows the resulting disc spin speed profile.

FIG. 6 shows an improved disc spin speed profile.

### MODES FOR CARRYING OUT THE INVENTION

It should be noted that although the invention is described in the embodiment of a single layer disc to keep the explanation simple, the invention is not limited to single layer discs but can be applied to multilayer discs as well. A disc spin speed profile is in that case established per layer in the same fashion as for a single layer disc. The profiles thus obtained can be stored as individual disc spin speed profiles, each corresponding to a layer, or they can be appended to each other to forms a single contiguous disc spin speed profile that corresponds to the logical data area (which on a multilayer disc is also considered as a single contiguous data area).

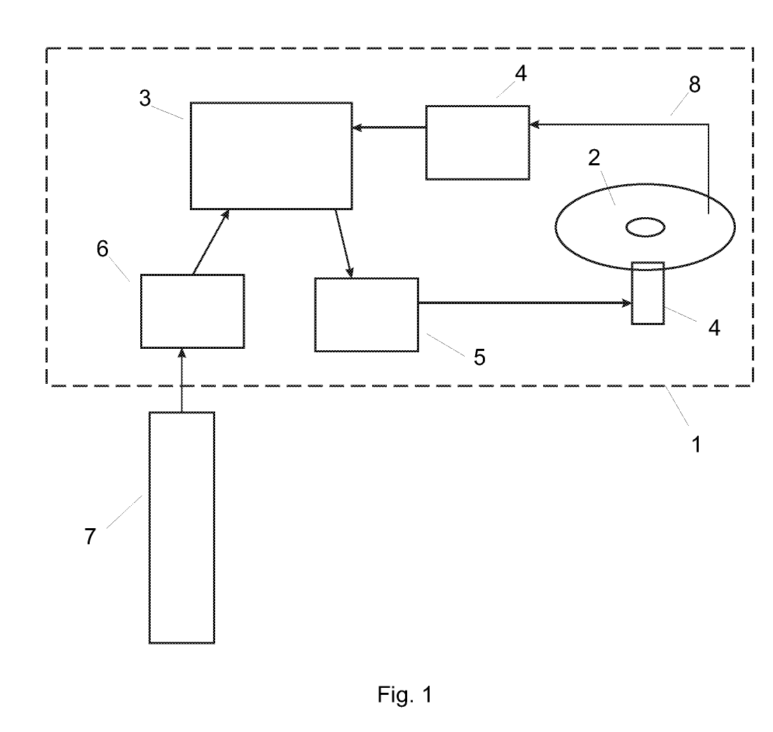

FIG. 1 shows a player according to the invention.

The player 1 comprises a processor 3 for controlling and coordinating the various tasks.

When a disc 2 is inserted the processor detects this and instructs the disc spin speed adjuster 5 to rotate the motor 4. An optical beam 8 is projected on the disc and data is read from the track of the disc 2 via reader 4.

If the disc 2 has an associated table indicating the maximum data rate required per zone of the track the player 1 will retrieve this information.

If the table is located on the disc the player will retrieve the table from the disc using the reader 4 and the processor 3. Once the table has been retrieved the processor provides the table to the disc spin speed adjuster 5. From this point on the disc spin speed adjuster 5 will adjust the spin speed of the motor 4 (and thus of the disc 2) to match the entry in the table for the zone of the track the player 1 is currently reading.

If the table is located externally, for instance on a server 7, the player retrieves the table via networking means 6. Once the table has been retrieved the processor provides the table to the disc spin speed adjuster 5. From this point on the disc spin speed adjuster 5 will adjust the spin speed of the motor 4 (and thus of the disc 2) to match the entry in the table for the zone of the track the player 1 is currently reading.

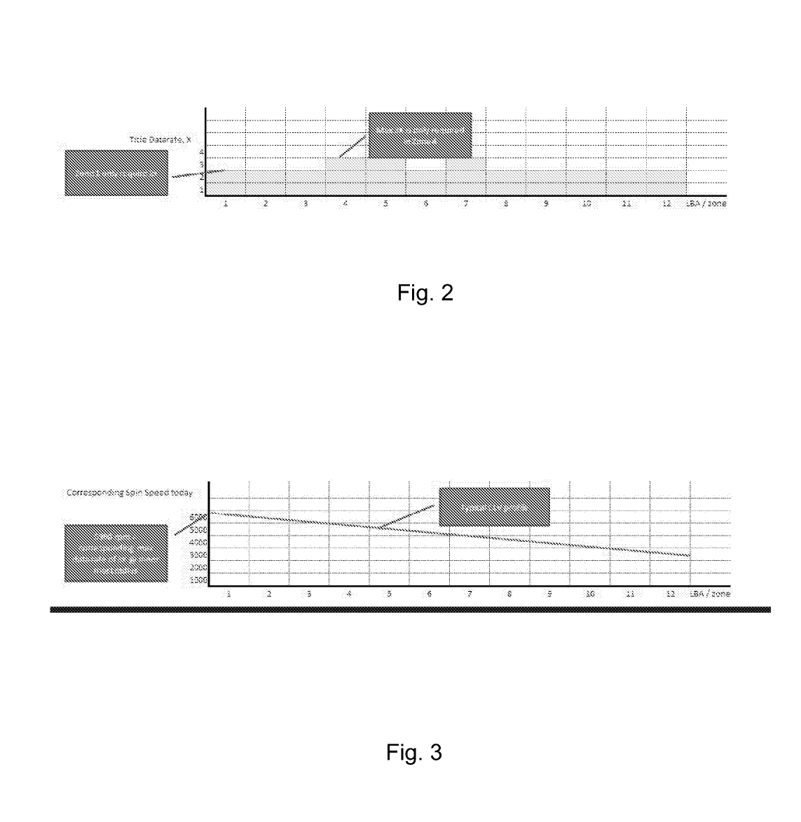

FIG. 2 shows a maximum data rate profile for a disc.

The track on the disc is divided into several zones and a maximum data rate of each zones per layer are provided in the table. The zones are defined based on LBA which is derived from the radial position. The zones can be different for each layer on a multi layer disc. The content owner specifies the maximum data rate encountered in all the zones and this data rate indicator is stored in a table in a specified location on the disc or remotely on a server.

The drive will use the data rate information and design a disc spin speed profile that can deliver the maximum data rate defined in each zone. The information from disc can be read by the drive during start up before playing back the main movie feature.

FIG. 2 shows an example of a typical movie title with data rate information at 12 zones in one layer. It is assumed the disc standard specifies the max data rate to 3×. As can be seen in this example, the title only requires maximum 3×data rate in Zone 4, 5 & 7. In the other zones the maximum data rate the drive will encounter is a 2×data rate.

FIG. 3 shows a disc spin speed profile as used by the prior art.

The data rates as shown in FIG. 2 result in a disc spin speed profile in a legacy player of 3×Constant Linear Velocity (CLV). This results in 5900 rpm at the start of zone 1 at the inner most radius of the disc. The disc spin speed profile when using Constant Linear Velocity is designed to meet the maximum data rate specified in the standard. As can be seen in FIG. 3, this results in a high disc spin speed in zone 1 of the disc which is much higher than actually needed to correctly play back the content of the disc in this zone.

As zone 1 has the highest disc spin speed (i.e. it is the zone requiring the highest number of record carrier rotations per minute to achieve a selected data rate of all zones on the record carrier) the a menu, a set of bonus material files or a set of startup files required upon startup of the record carrier can best be positioned in zone 1. The menu, a set of bonus material files or a set of startup files required upon startup of the record carrier typically require a lower data rate compared to movie data, resulting in a reduction of the disc spin speed.

In addition sections of the movie data that require the lowest data rate of all sections of the movie can be positioned in the inner zones of the record carrier, reducing the data rate in the inner zones, and consequently reducing the disc spin speed for these zones. Even though the repositioning of low data rate section of data and movies inherently introduces some seek actions by the player during playback, these jumps can be easily handled using the buffer that is already present in all current players to be able to seamlessly play video during a layer jump.

The record carrier startup files can be accompanied by an additional table holding a read sequence indicator indicating an optimal read sequence for the set of record carrier startup files. By reading the additional table the player can retrieve the record carrier startup files in an optimal fashion reducing or eliminating the need for the optical pickup unit of the player to return to the table of content of the record carrier each time after completing the retrieval of a record carrier startup file. The seek time of the optical pickup unit can be considerable so eliminating two seeks (a seek back to the table of content and another seek to the next record carrier startup file) before the retrieval of each record carrier startup file results in a substantial reduction time required for startup of the record carrier. If zone 1 has not enough room to store the record carrier startup files and/or menus and/or bonus material files, zone 2 can be used to store the superfluous record carrier startup files and/or menus and/or bonus material files.

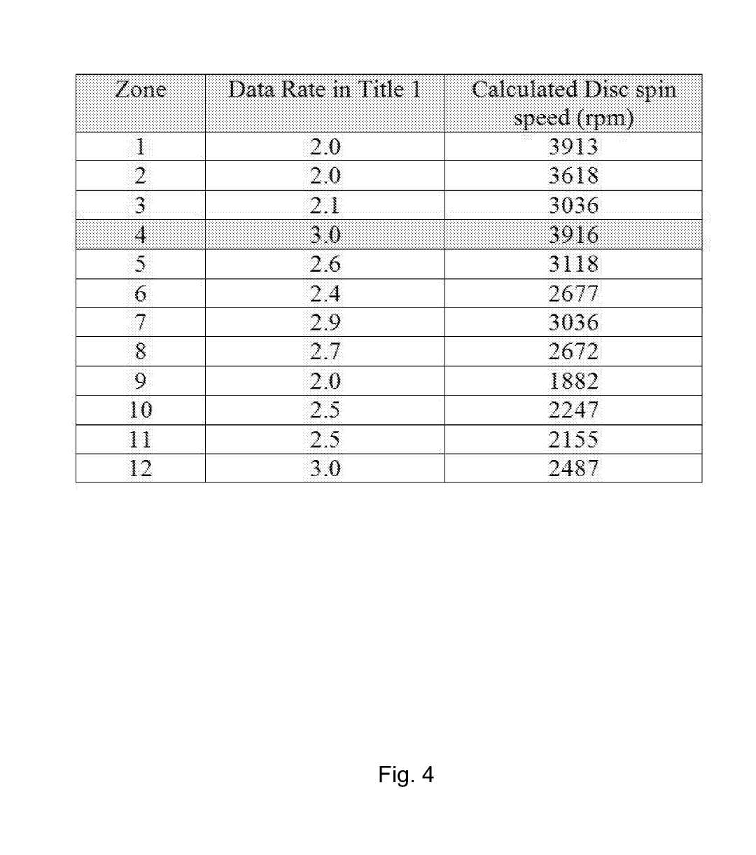

FIG. 4 shows a table with the maximum data rate per zone of the disc.

Table 1 provides a data rate indications per zone of the disc. It is the maximum data rate that the drive will encounter in this zone needed to properly play back the content in this zone. The drive is thus able, using this table to calculate the corresponding disc spin speed profile from the data rate requirements of the 12 zones obtained from the table by using the following formula:

Disc Spin Speed=60/(2×Radius (Zone)×PI/linear velocity)×2

The drive subsequently determines the suitable “Max N-RPM PCAV_X-CLV” profile to play back the title. The “Max N-RPM PCAV_X-CLV” profile uses a combination of constant angular velocity at inner radius and constant linear velocity for outer radius. Using this profile it is easy to define a disc spin speed profile which satisfies the minimum disc spin speed requirement for each zone of the disc. The method to determine parameter N & X of the profile is determined as follows.

The variable “Max N” for the Constant Angular Velocity portion is calculated by the data rate information from the disc.

The variable X for the CLV portion of the profile is defined by the maximum bit rate defined by the disc standard. For this example, if a particular disc format require 3×over-speed for the data rate, X=3.

Max N=Maximum (Calculated Disc Spin Speed {Zone 1, Zone 2 . . . Zone N}) From the calculated disc spin speed for all zones, the maximum disc spin speed for the disc (Max N-rpm) can be easily determined. In this example for Title 1, Max N (calculated)=3916.

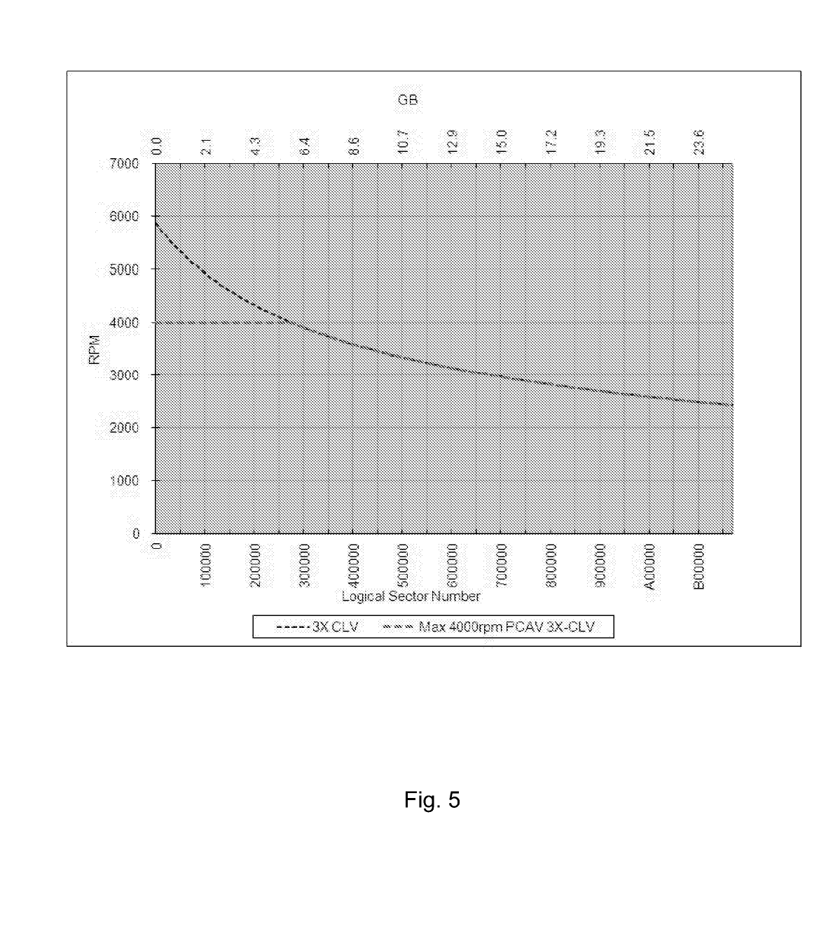

FIG. 5 shows the resulting disc spin speed profile.

FIG. 5 shows the resulting disc spin speed profile as based on the values in the table of FIG. 4.

As can be seen, the disc spin speed profile no longer has a very high disc spin speed of 5900 rpm at the beginning of zone 1, but instead the disc spin speed profile now uses a Constant Angular Velocity (CAV) of 4000 rpm as this is all that is needed to properly play back the content of this zone. At approximately 6GB (approximately Logical Sector Number 27000) the disc spin speed profile abandons the CAV approach and uses 3×CLV for the remainder of the disc.

Thus a reduction in disc spin speed is obtained while still guaranteeing the proper playback of the content across all zones of the disc.

As explained for FIG. 3, as zone 1 has the highest disc spin speed (i.e. it is the zone requiring the highest number of record carrier rotations per minute to achieve a selected data rate of all zones on the record carrier) the a menu, a set of bonus material files or a set of startup files required upon startup of the record carrier can best be positioned in zone 1. This constitutes a further improvement as the menu, a set of bonus material files or a set of startup files required upon startup of the record carrier typically require a lower data rate compared to movie data, in the example of FIG. 5 for instance requiring a disc spin speed of 3000 RPM versus the disc spin speed of 4000 RPM, resulting in a further reduction of the disc spin speed and thus a reduction in energy consumption and noise. In addition sections of the movie data that require the lowest data rate of all sections of the movie can be positioned in the inner zones of the record carrier, reducing the data rate in the inner zones, and consequently reducing the disc spin speed for these zones.

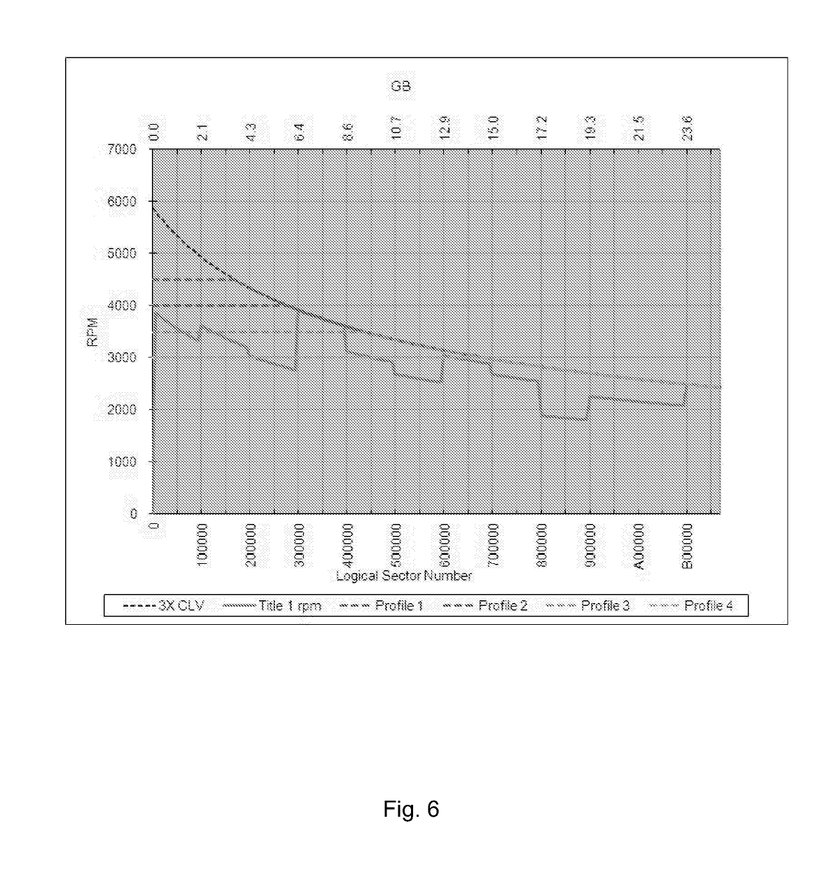

FIG. 6 shows an improved disc spin speed profile for the disc of FIG. 2.

A set of disc spin speed profiles can be predefined, for instance with a CAV of 4500, 4000, 3500, 3000 rpm.

These are shown in FIG. 6 as 4 different CAV sections with 4500, 4000, 3500 and 3000 rpm.

With the values of N in “Max N-RPM PCAV_3-CLV” known, the drive can select the slowest disc spin speed profile from a pre-defined “Max N-rpm PCAV 3×CLV” each having a different CAV part of the disc spin speed profile (of 5900, 4500, 4000, 3500, 3000 rpm). In the example of FIG. 6, the disc spin speed profile with a CAV section of 4000 rpm is chosen as it is the closest value that is still higher than the calculated N of 3916.

For the example of FIG. 6 the profile “Max 4000-rpm PCAV 3×CLV profile is selected to meet the maximum data rate required by the movie on the disc and achieve lower maximum disc spin speed as compared to a legacy CLV profile.

Beware that the data rate profile use din FIG. 6 differs from the data rate profile in FIG. 2.

To further improve the disc spin speed for the data rate profile given in FIG. 2, the disc spin speed profile can adopt 2×CLV after zone 7 as the remainder of the zones 8 through 12 on the disc only need a maximum of 2×data rate.

1. A disc shaped record carrier comprising a track for holding data characterized in that the track comprises multiple zones and in that the record carrier is associated to a table holding data rate indicators indicating for each one of the multiple zones an optimal read/write data rate where the optimal read/write data rate is based on a maximum data rate required by the data held in the corresponding zone.

2. A disc shaped record carrier as claimed in claim 1, where the data rate indicator indicates a maximum data rate of the data held in the corresponding zone.

3. A disc shaped record carrier as claimed in claim 1 where the table is located on a server.

4. A disc shaped record carrier as claimed in claim 1 where the table is located on the record carrier.

5. A disc shaped record carrier as claimed in claim 4, where the table is located in a lead-in area of the record carrier.

6. A disc shaped record carrier as claimed in claim 4, where the table is recorded in a data area of the record carrier.

7. A disc shaped record carrier as claimed in claim 6, where the table is recorded in a file.

8. A disc shaped record carrier as claimed in claim 1, where the record carrier comprises a menu, a set of bonus material files or a set of startup files required upon startup of the record carrier, located in a zone requiring the highest number of record carrier rotations per minute to achieve a selected data rate of all of the multiple zones on the record carrier.

9. A disc shaped record carrier as claimed in claim 8, where the record carrier comprises an additional table holding a read sequence indicator indicating an optimal read sequence for the set of record carrier startup files.

10. A disc shaped record carrier as claimed in claim 1, where sections of the data requiring the lowest data rate of all data sections are located in a zone requiring the highest number of record carrier rotations per minute to achieve a selected data rate of all of the multiple zones on the record carrier.

11. A server comprising a table relating to a disc shaped record carrier comprising a track for holding data, characterized in that the track comprises multiple zones and in that the table holds data rate indicators indicating for each one of the multiple zones of the track an optimal read/write data rate where the optimal read/write data rate is based on the data held in the corresponding zone.

12. A server as claimed in claim 11, where the data rate indicator is a local change of data rate.

13. A server as claimed in claim 11, where the data rate indicator is a minimum data rate indicator.

14. A player for retrieving content from a disc as claimed in claim 1, characterized in that characterized in that the player comprises a table retriever and a disc spin speed adjuster, where, when retrieving a zone, the disc spin speed adjuster is arranged to adjust the disc spin speed of the record carrier to achieve a data rate equal to the maximum data rate as derived by the table retriever from the table for that zone of the track.

15. A player as claimed in claim 14, where the data rate indicator indicates a maximum data rate of the data held in the corresponding zone.

16. A player as claimed in claim 14, where the disc spin speed adjuster is arranged to create a disc spin speed profile which is a combination of a constant angular velocity profile and a constant linear velocity profile.

17. A player as claimed in claim 14 where the player comprises networking means for retrieving the table from a server.

18. A player as claimed in claim 14 where the table is located on the record carrier.

19. A player as claimed in claim 14, where the player is arranged to retrieve from the record carrier a set of startup files required upon startup of the record carrier, located in a zone requiring the highest number of record carrier rotations per minute to achieve a selected data rate of all of the multiple zones on the record carrier.

20. A player as claimed in claim 19, where the table retriever is arranged to retrieve an additional table holding a read sequence indicator indicating an optimal read sequence for the set of startup files and the player is arranged to retrieve the startup files in the read sequence as indicated by the additional table.

21. A player as claimed in claim 14, where the player is arranged to retrieve sections of the data requiring the lowest data rate of all data sections are retrieved from a zone requiring the highest number of record carrier rotations per minute to achieve a selected data rate of all of the multiple zones on the record carrier.
